(19) United States
(12) Patent Application Publication
(10) Pub. No.: US 2009/0289763 A1
(43) Pub. Date: Nov. 26, 2009

(54) Personal safety accessory device

(75) Inventors: Dean M. Chriss, Euclid, OH (US); Barry J. Markwitz, Solon, OH (US)

Correspondence Address: James A. Hudak, Esq., Suite #304, 29425 Chagrin Blvd., Cleveland, OH, 44122, US

(73) Assignee: Time Keeping Systems, Inc.

(21) Appl. No.: 12/154,392

(22) Filed: May 23, 2008

(51) Int. Cl. G08B 21/02

(52) U.S. Cl. 340/7.5

(57) ABSTRACT

A personal safety accessory device that is worn or carried by the user along with a communication device, such as a cellular telephone, is disclosed. In an emergency situation, the personal safety accessory device is actuated causing the accessory device to emit a short range radio frequency signal that is received by the communication device which attempts to establish a connection to a predetermined address. If a connection is established, the communication device transmits a message, which may consist of voice and/or data to the predetermined address. The connection may be automatically terminated after successful transmission of the message or the connection may remain intact until it is manually terminated. If the connection is not successfully established, the communication device will repeatedly attempt to establish the connection until it is successfully established or the connection has been manually terminated. Alternatively, the communication device will attempt to sequentially establish a connection to a predetermined list of addresses in order to transmit a message, which may consist of voice and/or data, to same.

### TECHNICAL FIELD

The present invention relates, in general, to a personal safety accessory device and, more particularly, to a personal safety accessory device that can be easily added to a commonly used communication device, such as a cellular telephone or a Personal Digital Assistant (PDA).

### BACKGROUND ART

There are numerous personal safety devices that are presently available. Such devices range from medical alert systems used by individuals to Personal Alert Safety Systems (PASS) used by fire departments. These systems are effective but are not flexible with respect to their applications. Typically, such systems are designed for and function correctly in a narrow set of applications.

For example, transmitter pendants typically worn by the users of medical alert systems are effective within a limited range from a base unit that is connected to a telephone line. Problems occur when a person having relatively high level of mobility uses such a system and an accident occurs outside the communication range of the pendant. Similar systems are not suitable for assuring the safety of workers who work alone or who travel long distances to remote work sites.

In contrast, large and complex Personal Alert Safety Systems (PASS) used by fire departments have a much greater range than the medical alert systems, but such systems are expensive, complex and inappropriate for use in many industrial or commercial applications or as medical alert systems. In this instance, the maximum distance of a user from a manned base unit depends on the range of the transmitter worn by the user. This range may be adequate for a large building or industrial site, but may be inadequate to assure the safety of individuals who work alone and travel long distances to remote work sites.

In view of the foregoing disadvantages associated with presently available safety alert systems, it has become desirable to develop a personal safety accessory device that can be easily adapted to a commonly used communication device, such as a cellular telephone or a Personal Digital Assistant (PDA).

### SUMMARY OF THE INVENTION

The present invention solves the problems associated with the prior art safety alert systems and other problems by providing a personal safety accessory device that is easily adapted to a commonly used communication device, such as a cellular telephone or a Personal Digital Assistant (PDA). The personal safety accessory device of the present invention is battery operated and does not require a physical connection with the associated communication device since it utilizes one of several industry standards for short-range communication, such as Bluetooth, Near Field Communication (NFC), or other communication system. The personal safety accessory device of the present invention utilizes means for manual activation by the user. Additionally and alternatively, the personal safety accessory device of the present invention can incorporate means for automatic activation if the device detects a problem situation, such as no user movement for a predetermined period of time or an orientation of the device that is defined as a problem situation. When activation occurs, the device sends a signal to the associated communication device. When the associated communication device receives the signal it causes software within the communication device to be executed. The software initiates communication to one or more predetermined addresses, such as telephone numbers or Internet Protocol (IP) addresses. When communication has been established, a message that the user requires assistance is transmitted. This message can be in the form of a synthesized or recorded voice and/or data depending upon the message destination and the specific implementation of the present invention. If the associated communication device is a cellular telephone and the software is configured so as to place a call to the 911 service, the user's location can be determined according to the E911 standard. If the associated communication device incorporates positioning technology, such as global or local positioning, the user's position can be transmitted by a synthesized voice or as data.

It can be seen that applications of the present invention can vary widely. In a relatively simple application, a cellular telephone is utilized as the associated communication device and the software within the cellular telephone is configured to place a telephone call and transmit a message using synthesized or recorded voice to the 911 service when activation of the personal safety accessory device occurs. Additionally or alternatively, the software within the cellular telephone can be configured to place a series of telephone calls, each transmitting a message using a synthesized or recorded voice to one or more individuals when activation of the personal safety accessory device occurs.

In more complex applications, a global positioning system (GPS) and Internet enabled cellular telephone or Personal Digital Assistant (PDA) can be utilized as the associated communication device and the software within the associated communication device is configured to connect to a central computer system via the Internet and transmit a data message when activation of the personal safety accessory device occurs. The transmitted data can include the identity of the user of the personal safety accessory device and the user's exact location. Software within the central computer system analyzes the data and alerts the appropriate individuals or agencies via telephone calls, email messages, pager, fax, and other messaging types. Similarly, the central computer system can alert an operator or operators at a manned monitoring center via a computer terminal or work station displays.

As such, the personal safety accessory device of the present invention comprises means to activate and deactivate the accessory device, means to uniquely associate the accessory device with a communication device to which the personal safety accessory device is an accessory, means to create visual and audible alarms on or in the personal safety accessory device when short range radio frequency communication between the personal safety accessory device and the associated communication device is lost and/or a short range radio frequency alarm signal is transmitted from the personal safety accessory device, and means to transmit a short range radio frequency alarm signal to the associated communication device under certain conditions. Such conditions include the manual initiation of an alarm condition by the user through the actuation of a push button or the like, or the automatic initiation of an alarm by means of a motion detector when the user has not physically moved for longer than a predetermined period of time. The means to automatically initiate an alarm incorporates visual and audible alarms on or in the personal safety accessory device of the present invention so as to notify the user of the impending transmission of the short range radio frequency alarm signal during a predetermined time interval before the short range radio frequency alarm signal transmission begins. This permits the user to deactivate the personal safety accessory device to prevent false alarm signals from being transmitted.

Operating in conjunction with the personal safety accessory device of the present invention, but within a separate long-range communication device, such as a cellular telephone or a Personal Data Assistant (PDA), to which the personal safety accessory device is an accessory, is the software component of the present invention. This software component comprises means to manually activate and deactivate the software, means to uniquely associate the communication device with the personal safety accessory device, means to activate visual and/or audible alarms on the associated communication device, (if such alarms are available), when short range radio frequency communication between the associated communication device and the personal safety accessory device is lost or a short range radio frequency alarm signal is received from the personal safety accessory device, and means causing the associated communication device to transmit a long range message consisting of synthesized or recorded voice and/or data to a predetermined address or addresses when short range communication between the associated communication device and the personal safety accessory device is lost for longer than a predetermined period of time or a short range radio frequency alarm is received from the personal safety accessory device.

In one implementation of the present invention, software is loaded into the communication device to which the personal safety accessory device is an accessory. A unique identifier of the personal safety accessory device and its communication device are entered into both devices, and addresses, such as telephone numbers or Internet Protocol (IP) addresses, are entered into the communication device. The personal safety accessory device and the associated communication device communicate with one another periodically so that each device can determine the presence of the other device. For example, the personal accessory device can transmit its unique identifier to its associated communication device and the associated communication device can respond to the personal safety accessory device with its own unique identifier. If the personal safety accessory device loses communication with its associated communication device, visible and available alarms within the personal safety accessory device are activated. If the associated communication device loses communication with the personal safety accessory device, any available local visible and audible alarms are activated. If communication is not restored and the associated communication device is not manually deactivated within a predetermined period of time, a voice and/or data message indicating a problem is transmitted to the previously entered address or addresses.

The personal safety accessory device of the present invention is worn or otherwise carried by the user along with its associated communication device, such as a cellular telephone. In an emergency situation, a push button or other manual or automatic means for initiating an alarm changes the state of at least one pin of a digital input/output port causing hardware and firmware components of the personal safety accessory device to emit a short range radio frequency signal. This short range radio frequency signal is received by the associated communication device causing this communication device to execute software that has been pre-loaded into the associated communication device. This software causes the associated communication device to attempt to establish a connection to a predetermined address. If the connection is established, the software causes the associated communication device to transmit a message to the predetermined address. This message may consist of voice and/or data, as appropriate. The connection may be automatically terminated after transmission of the message has been successfully completed or the connection may remain intact until it is manually terminated. If the connection is not successfully established, the software will repeatedly attempt to establish the connection until it is either successfully established or the connection is manually terminated.

In another implementation of the present invention, rather than attempting to establish a connection to a predetermined address, the software within the associated communication device attempts to establish a connection with the first address in a predetermined list of addresses. If the connection is established with the first address, the software causes the associated communication device to transmit a message to the first address. This message may consist of voice and/or data, as appropriate. After the message transmission has been completed, the connection may be automatically terminated and no further action may be taken, or the connection may be automatically terminated and the software may then attempt to establish a connection to the next address in the predetermined list of addresses, or the connection may remain intact until it is manually terminated. If a connection is not established to the first address, the software may attempt to establish a connection to the next address in the predetermined list of addresses, in a circular manner, until at least one connection is established and the message has been successfully transmitted. In still another implementation of the present invention, the software may attempt to establish a connection to the next address in the predetermined list of addresses, in a circular manner, until each connection has been established and the message has been successfully transmitted to each address in the predetermined list of addresses.

### BRIEF DESCRIPTION OF THE DRAWINGS

FIG. 1 is a schematic diagram of an implementation of the present invention using synthesized or recorded voice communication.

FIG. 2 is a schematic diagram of an implementation of the present invention using data communication.

FIG. 3 is a schematic diagram of the personal safety accessory device of the present invention.

FIG. 4 is a flow chart of the software logic that is executed by the personal safety accessory device to detect its associated communication device.

FIG. 5 is a flow chart of the software that is executed by the associated communication device to detect its associated personal safety accessory device.

FIG. 6 is a flow chart of the software that is executed by the associated communication device when an alarm signal is received from its associated personal accessory device.

### DESCRIPTION OF THE PREFERRED EMBODIMENT

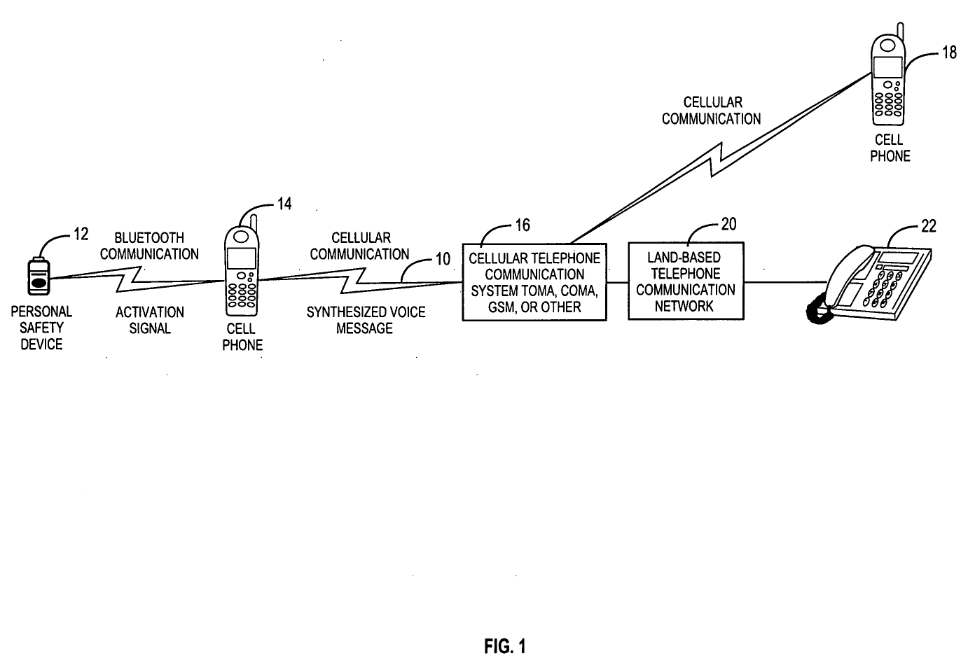

Referring now to the Figures where the illustrations are for the purpose of describing the preferred embodiment of the present invention and are not intended to limit the invention described herein, FIG. 1 is a schematic diagram of one implementation of a system 10 utilizing the concepts of the present invention and using previously recorded and stored, or synthesized voice message communication to accomplish same. As such, a personal safety accessory device 12 of the present invention is utilized to activate a cellular telephone 14 through Bluetooth, Near. Field Communication (NFC), or other communication system. The cellular telephone 14, in turn, transmits a previously recorded and stored, or synthesized voice message via a cellular telephone communication system 16 of the appropriate type, such as a TDMA (Time Division Multiple Access) system, CDMA (Code Division Multiple Access) system, GSM (Global System for Mobile Communications), or other communication system to another cellular telephone 18 or to a typical landline telephone by means of the landline-based telephone communication network 20.

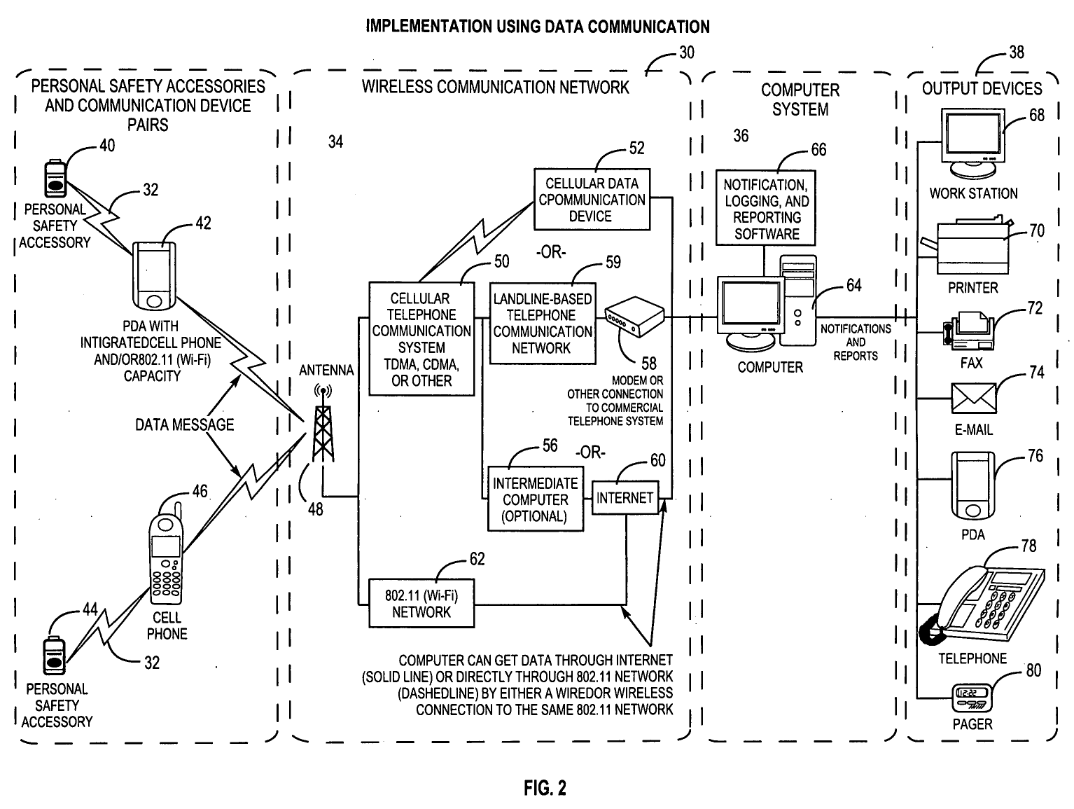

Referring now to FIG. 2, a schematic diagram of another implementation of a system 30 utilizing the concepts of the present invention and using data communication to accomplish same is illustrated. The system 30 includes pairs of personal safety accessory devices and associated communication devices, shown generally by the numeral 32, a wireless communication network, shown generally by the numeral 34, a computer system, shown generally by the numeral 36, and a plurality of output devices, shown generally by the numeral 38.

The pairs 32 of personal safety accessory devices and associated communication devices can include, for example, a personal safety accessory device 40 and its associated Personal Digital Assistant (PDA) 42 with integrated cellular telephone and/or 802.11 (Wi-Fi) capability. Additionally and alternatively, a personal safety accessory device 44 and its associated cellular telephone 46 can be utilized. In any case, the personal safety accessory devices 40 and 44 can activate their respective associated communication devices 42 and 46 by means of Bluetooth or Near Field Communication (NFC), and the respective communication devices 42 and 46 are connectable to a computer 64 via a wireless communication network, shown generally by the numeral 34.

The wireless communication network 34 can utilize an existing cellular telephone communication system of the appropriate type, such as TDMA (Time Division Multiple Access) system, a CDMA (Code Division Multiple Access) system, or a GSM (Global System for Mobile Communication), shown generally by the numeral 50, or another type of system, that is connectable to an existing landline-based telephone network, shown generally by the numeral 54, or to the Internet 60, via an optional intermediate computer 56. A modem or other device 58 is utilized to connect the landline-based telephone network 54 to a computer 64 to receive data transmissions from the cellular telephone 46 and/or the PDA 42. Alternatively, the computer 64 is connectable to the Internet 60 to receive data transmissions from the cellular telephone 46 and/or the PDA 42, via the existing cellular telephone communication system 50. Furthermore, the computer 64 can receive data communications from the cellular telephone 46 and/or the PDA 42 directly via a Wi-Fi network 62 based on the IEEE 802.11 specification, or from the Wi-Fi network 62, via the Internet 60. Also, the computer 64 can receive data communications from the cellular telephone 46 and/or the PDA 42 from the existing telephone communication system 50, via a cellular data communication device 52.

The computer 64 is equipped with software, shown generally by the numeral 66, for the purposes of notifying appropriate persons, logging, and generating reports regarding messages received from the cellular telephone 46 and/or the PDA 42. The computer 64 generates commands, as instructed by the software 66, to produce notifications and reports at various output devices 38, which include work stations 68, printers 70, and facsimile machines 72. Additionally or alternatively, the computer 64 can provide information and notify individuals of exceptions that require attention through email messages 74, PDAs 76, cellular and other telephones 78, or pagers 80.

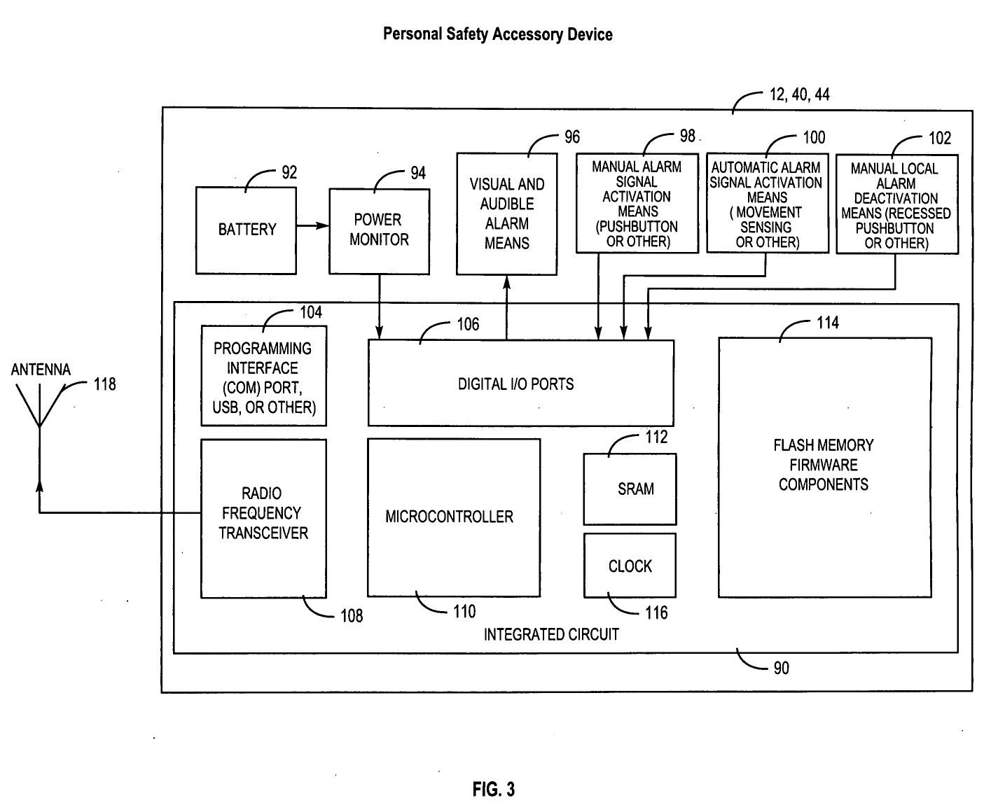

Referring now to FIG. 3, a schematic diagram of the personal safety accessory device 12, 40, 44 of the present invention is illustrated. The personal safety accessory device 12, 40, 44 includes an integrated circuit 90, a battery 92, power monitor 94, visual and audible alarm devices 96, a manual alarm signal activation device 98, an automatic alarm signal activation device 100 and a manual local alarm deactivation device 102. The integrated circuit 90 includes a programming interface 104, digital input/output ports 106, a radio frequency transmitter 108, a processor 110, a SRAM 112, and flash memory 114. The flash memory 114 stores the operating system and associated programs of the personal safety accessory device 12, 40, 44, which are loaded into the flash memory 114 by means of the programming interface 104. The operating system and associated programs stored in the flash memory 114 are executed by the processor 110 utilizing the SRAM 112 and a clock 116. When executing, the operating system and associated programs perform functions necessary for the operation of the personal safety accessory device 12, 40, 44, including monitoring the status of the inputs and controlling outputs of the digital input/output ports 106, and transmitting and receiving data via the radio frequency transceiver 108 and an antenna 118. The monitored inputs include a manual alarm signal activation device 98 (which may be a push button, or the like), an automatic alarm signal activation device 100 (which may be a movement sensing device, or the like) and a manual local alarm deactivation device 102 (which may be a push button, or the like). The outputs controlled include visual and audible alarms of the PSAD. The battery 92 provides power for the operation of the integrated circuit 90 and the associated circuitry of the personal safety accessory device 12, 40, 44. The power monitoring circuit 94 monitors battery condition and provides battery condition data as an input to the digital input/output ports 106 which are monitored, as previously described.

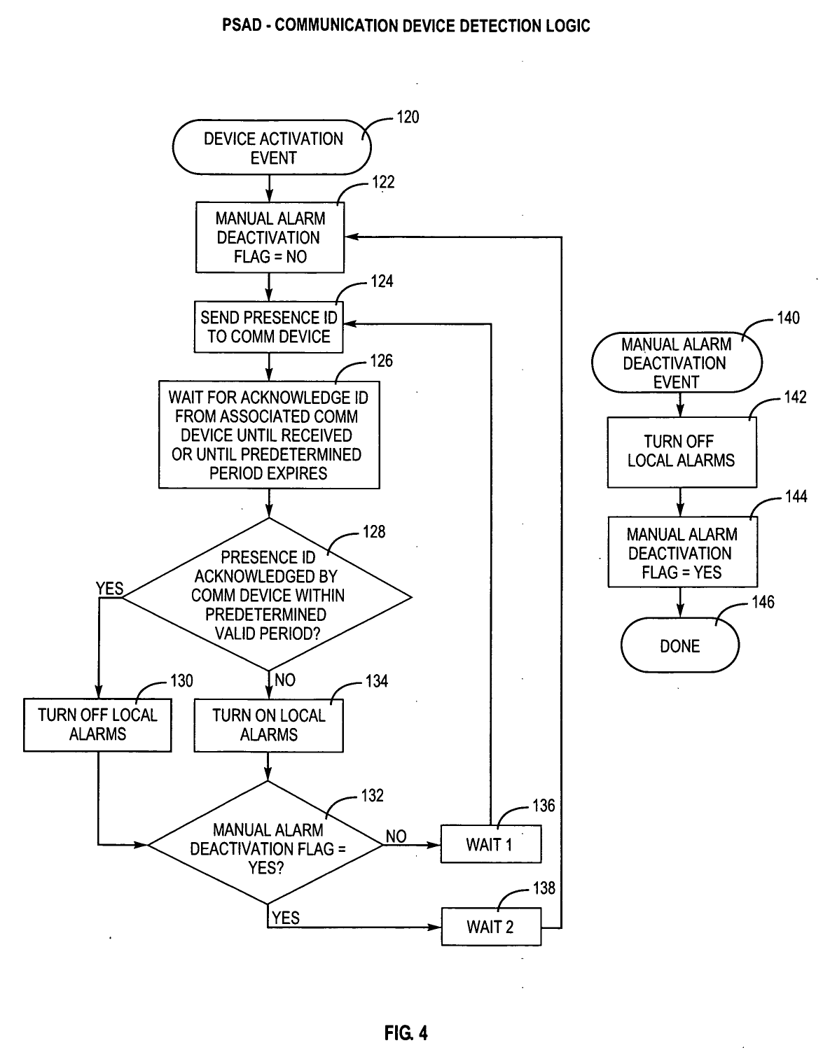

Referring now to FIG. 4, a flow chart of the communication device detection logic utilized by the present invention and executed by the personal safety accessory device is illustrated. As shown, when the personal safety accessory device 12, 40, 44 is activated in block 120, the software illustrated in this Figure immediately begins being executed in the personal safety accessory device. The manual alarm deactivation flag is set to NO in block 122 indicating that the local visible and audible alarms of the personal safety accessory devices 12, 40, 44 are not manually deactivated. The personal safety accessory device 12, 40, 44 then transmits a presence signal (a unique identifier) in block 124 utilizing a short range communication technology, such as Bluetooth or Near Field Communication (NFC). In block 126, the personal safety accessory device 12, 40, 44 waits to receive an acknowledgement from its associated communication device of the presence signal (identifier) transmitted in block 124. The acknowledgement consists of at least the unique identifier of the communication device. The logic waits until either the acknowledgement signal has been received or until a predetermined period of time has elapsed. A determination is then made in block 128 as to whether an acknowledgement of the presence signal (identifier) has been received from the associated communication device or whether the predetermined period of time has elapsed without the reception of the acknowledgement. If an acknowledgement has been received, any previously activated local alarms are turned off in block 130 and the logic then proceeds to block 132. If the predetermined period of time has elapsed without the reception of an acknowledgement, the local and audible alarms are turned on in block 134 informing the user that the personal safety accessory device 12, 40, 44 cannot communicate with its associated communication device, and the logic then proceeds to block 132. A determination is then made in block 132 as to whether the manual alarm deactivation flag has not been set to YES. If the manual alarm deactivation flag has not been set to YES, the logic proceeds to block 136 where it waits for a predetermined period of time before beginning again at block 124. If in block 132, a determination is made that the manual alarm deactivation flag is set to YES, the logic proceeds to block 138 where it waits for a separately configurable period of time before beginning again at block 122.

Software within the personal safety accessory device 12, 40, 44 includes a feature allowing the user to temporarily turn off local visible and audible alarms when the manual local alarm deactivation devices 102, as shown in FIG. 3, are activated. Activation of the manual local alarm deactivation devices 102 causes a manual alarm deactivation event, as shown in block 140, causing the software to turn off visible and audible alarms if the alarms are active, as shown in block 142. The logic next proceeds to block 144 where the manual alarm detection flag is set to YES, indicating that the user has manually deactivated the alarms. The logic finishes, as indicated in block 146, and is then ready to accept another manual alarm deactivation event at any time.

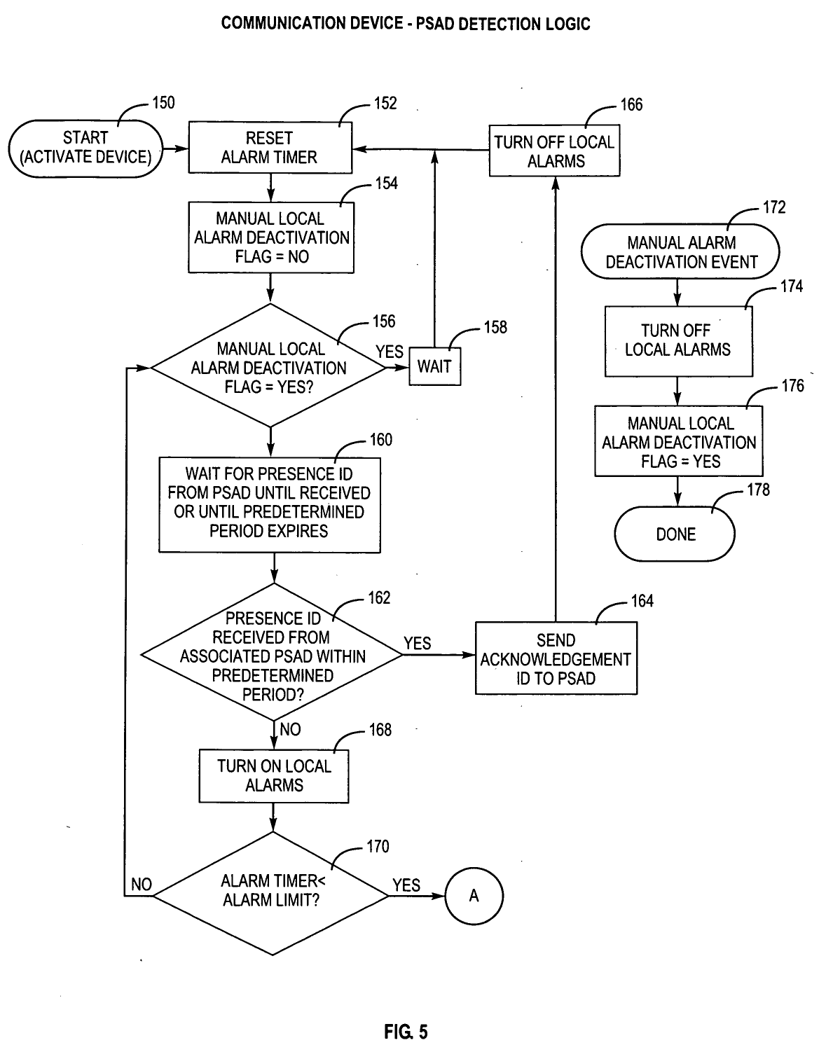

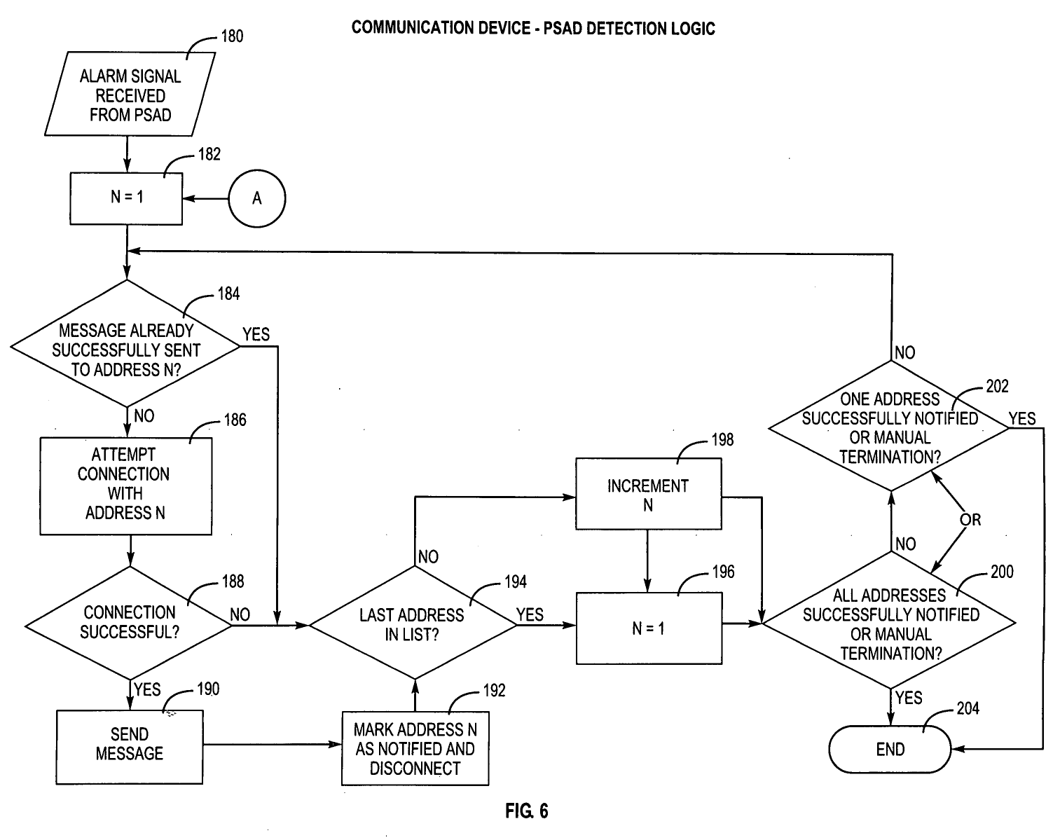

A flowchart of the personal safety accessory device detection logic utilized by the present invention and executed by the associated communication device is illustrated in FIG. 5. As illustrated, when the personal safety accessory device 12, 40, 44 is activated in block 150, the software illustrated in this Figure immediately begins being executed in the associated communication device and resets a continuously running timer in block 152. The manual local alarm deactivation flag is then set to NO in block 154 indicating that local visible and audible alarms of the associated communication device are not manually activated. A check is then made in block 156 to determine whether local visible and audible alarms of the associated communication device are manually deactivated. If so, the logic proceeds to block 158 where it waits for a predetermined period of time before resuming again beginning with block 152. Otherwise, the logic proceeds to block 160 in which the associated communication device waits to receive a presence signal (a unique identifier) from the personal safety accessory device 12, 40, 44. The logic waits until either the presence signal (identifier) is received by the associated communication device or until a predetermined period of time has elapsed. A determination is then made in block 162 as to whether the presence signal (identifier) was received from the personal safety accessory device 12, 40, 44 or whether the predetermined period of time elapsed without the reception of the presence signal (identifier). If the presence signal (identifier) was received from the personal safety accessory device 12, 40, 44, an acknowledgement consisting of at least the unique identifier of the associated communication device is transmitted utilizing a short range communication technology, as shown in block 164, causing local and visible alarms to be turned off in block 166 and the logic begins again in block 152. If the predetermined period of time elapsed without the reception of the presence signal (identifier) from the personal safety accessory device 12, 40, 44, local visible and audible alarms are turned on in block 168 informing the user that communication with the personal safety accessory device 12, 40, 44 has been lost. The logic then proceeds to block 170 where a determination is made as to whether the alarm timer has exceeded a predetermined limit. If so, the associated communication alarm software, illustrated in FIG. 6 and hereinafter described, is executed. Otherwise, the logic begins again starting with block 156.

Software within the associated communication device includes a feature that allows the user to temporarily turn off local visible and audible alarms and temporarily prevent the software illustrated in FIG. 6 from being executed if such execution has not already begun. The foregoing causes a manual deactivation event, as shown in block 172, causing the software to turn off local and visible alarms if the alarms have been activated, as shown in block 174. The logic then proceeds to block 176 where the manual local alarm deactivation flag is sent to YES, indicating that the user has manually deactivated the alarms. The logic finishes, as indicated in block 178, and is then ready to accept another manual alarm deactivation event at any time.

With the personal safety accessory device and its associated communication device both activated and communicating with one another, the local visible and audible alarms on either device will not be activated, and the associated communication device alarm software, as illustrated in FIG. 6 and hereinafter described, will not execute until a manual or automatic alarm signal activation device of the personal safety accessory device 12, 40, 44 is activated causing hardware and firmware of the personal safety accessory device 12, 40, 44 to transmit an alarm and alarm signal utilizing short range communication technology, such as Bluetooth or Near Field Communication (NFC), as shown in FIG. 4. When a manual alarm signal activation device 98 or an automatic alarm signal activation device 100 of the personal safety accessory device 12, 40, 44 is initiated, an alarm signal is transmitted utilizing short range communication technology. The alarm signal consists of at least the unique identifier of the personal safety accessory device 12, 40, 44 and a flag indicating that an alarm condition has occurred.

Referring now to FIG. 6, a flow chart of the associated communication device alarm logic of the present invention is illustrated. As illustrated, when an alarm signal is received by the associated communication device in block 180, or when the logic illustrated in FIG. 5 results in the execution of block 170 of that Figure due to an exceeded alarm timer limit, a counter N is set to 1, as shown in block 182. A determination is then made in block 184 as to whether an alarm message consisting of voice and/or data has already been set to address N in a predetermined list of addresses. Since no messages have yet been sent, the logic of block 186 is executed and a connection with address N is attempted. In block 188 a determination is made as to whether the connection attempted in block 186 has been successful. If so, an alarm message is sent, as shown in block 190, and address N is marked as having been notified of the alarm, as shown in block 192. A determination is then made in block 194 as to whether address N is the last address in the predetermined list of addresses, as is the case if a determination was made in block 184 that the alarm message had already been sent to address N, or if a determination was made in block 188 that the connection attempted in block 186 was not successful. If address N is the last address in the predetermined list of addresses, N is set equal to 1, as shown in block 196. If N is not the last address in the predetermined list of addresses, N is incremented (N=2), as shown in block 198. In either case, the logic in one of the blocks 196 or 198 is then executed. Block 200 is executed if it is predetermined that all addresses in the list of addresses must be notified. Block 202 is executed if it is predetermined that only one address in the predetermined list of addresses must be notified. In either case a determination is made as to whether a manual termination of the notification process has been initiated. If so, the program ends in block 204. If a determination is made in block 200 or block 202 that any address that must be notified has not been notified, the logic repeats beginning again at block 184.

Certain modifications and improvements will occur to those skilled in the art upon reading the foregoing. It is understood that all such modifications and improvements have been deleted herein for the sake of conciseness and readability, but are properly within the scope of the following claims.

We claim:

1) A personal alert safety system comprising a personal safety accessory device capable of producing an output signal, a wireless device actuatable by said output signal produced by said personal safety accessory device and transmitting a wireless notification in response thereto, a receiving device having means responsive to said wireless notification, and means for transmitting said wireless notification produced by said wireless device to said receiving device.

2) The system as defined in claim 1 wherein said wireless device is a cellular telephone or other device having cellular telephone communication capabilities and said transmitting means comprises a cellular telephone network.

3) The system as defined in claim 1 wherein said wireless device is a cellular telephone or other device having cellular telephone communication capabilities and said transmitting means comprises a cellular telephone network and a landline-based telephone network.

4) The system as defined in claim 1 wherein said wireless device is a cellular telephone or other device having Wi-Fi communication capabilities and said transmitting means comprises a Wi-Fi network.

5) The system as defined in claim 1 wherein said wireless device is a cellular telephone or other device having Wi-Fi communication capabilities and said transmitting means comprises a Wi-Fi network and the Internet.

6) The system as defined in claim 1 further including a computer device which processes said wireless notification and transmits commands to said receiving device in response thereto.

7) The system as defined in claim 6 wherein said receiving device comprises various types of peripheral equipment.

8) A personal alert safety system comprising a personal safety accessory device capable of producing an output signal, a wireless device actuatable by said output signal produced by said personal safety accessory device and producing a synthesized voice message signal in response thereto, means responsive to said synthesized voice message signal, and means for transmitting said synthesized voice message signal to said synthesized voice message signal responsive means.
